(19) United States
(12) Patent Application Publication
(10) Pub. No.: US 2014/0102607 A1
(43) Pub. Date: Apr. 17, 2014

(54) TIRE WITH ROTATIONAL VISUAL DISPLAY

(71) Applicant: BRUCE WOODROW, Washington, DC (US)

(72) Inventor: BRUCE WOODROW, Washington, DC (US)

(21) Appl. No.: 13/649,296

(22) Filed: Oct. 11, 2012

(51) Int. Cl. B60C 19/00

(52) U.S. Cl. 152/151

(57) ABSTRACT

A tire with rotational visual display comprising a tire, where the tire includes an outer face, an inner edge and an outer edge; a first image on the outer face, where the first image is seen when the tire is in a still position; and a second image on the outer face, where the second image is seen when the tire rotates at a predetermined speed. The first image is arranged with a specific spacing to where when the predetermined speed is attained the second image is then seen. The second image of the tire with rotational visual display displays one of at least a word, phrase, picture, brand name, logo and slogan.

### BACKGROUND OF THE INVENTION

1. Field of the Invention

The present invention relates to a tire with a visual display, where when the tire rotates the visual display creates a word or symbol.

2. Description of Related Art

People are continuously thinking of new and creative ways to decorate and personalize their belongings. Some people are courageous enough to personalize their vehicles with unique paints, stickers, tire rims or window paintings. Some of the decorations may be permanent while others are temporary allowing for removable and replacement as desired by the user. Creative business people and corporations also utilize their vehicles as a useful marketing palate upon which they may advertise on the doors, windows and bumpers.

While placing decorative or informational postings on a vehicle is desirable, the vehicle decorator must continuously be aware not to obstruct the driver's view. This is why door panels and tires are optimal branding locations because they don't interfere with the windows. A problem with placing pictures or words on a tire is that this is only seen when the vehicle is stationary. Once the tire starts to rotate the image becomes blurred and eventually simply a smear of lines.

It would be desirable in the art to provide a way to decorate a vehicle on a non-typical location. It would also be beneficial in the art to provide a way to successfully advertise on a vehicle tire while the tire is in motion.

### SUMMARY OF THE INVENTION

In view of the foregoing disadvantages inherent in the prior art, the general purpose of the present invention is to provide a tire with visual display, configured to include all of the advantages of the prior art, and to overcome the drawbacks inherent therein.

Accordingly, an object of the present invention is to provide a tire with rotational visual display where an image appears when the vehicle tire rotates at a predetermined speed.

To achieve the above objects, in an aspect of the present invention, a tire with rotational visual display is described comprising a tire, where the tire includes an outer face, an inner edge and an outer edge; a first image on the outer face, where the first image is seen when the tire is in a still position; and a second image on the outer face, where the second image is seen when the tire rotates at a predetermined speed. The first image is arranged with a specific spacing to where when the predetermined speed is attained the second image is then seen. The second image of the tire with rotational visual display displays one of at least a word, phrase, picture, brand name, logo and slogan.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a tire with rotational visual display in a still position in accordance with an exemplary embodiment of the present invention; and

FIG. 2 depicts a perspective view of a tire with rotational visual display while rotating in accordance with an exemplary embodiment of the present invention.

Like reference numerals refer to like parts throughout the description of several views of the drawings.

### DETAILED DESCRIPTION OF THE DRAWINGS

The present invention relates to a tire with a visual display, where when the tire rotates the visual display creates a word or symbol. The tire includes a labeling technique that allows an image to be displayed on the tire once the vehicle reaches a predetermined speed. When still, the tire comprises an image that appears jumbled or fragmented. But once the tire starts to rotate and reaches an optimal speed a whole image is displayed due to the blurring of the fragmented image. The tire with rotational visual display is a fun and creative way for placing logos, slogans and images on a person's tires, reflecting the personality of the driver or the associated brands of the vehicle.

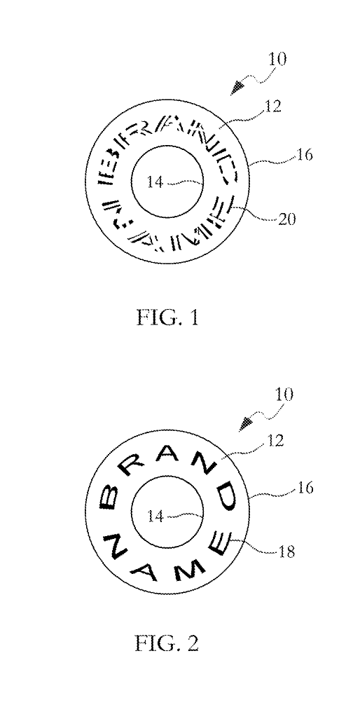

Turning now descriptively to the drawings, referring to FIG. 1, a perspective view of a tire with rotational visual display 10 is shown in accordance with an exemplary embodiment of the present invention. The tire with visual display 10 includes a front face 12 or outer face, where the outer face 12 includes an inner edge 14 and an outer edge 16. Along the outer face 12 may be a first image 20. The first image 20 is essentially non-decipherable and may appear as a fragmented or spaced image. The first image 20 may extend all the way around the outer face 12, and from the inner edge 14 to the outer edge 16 as desired by the user. The first image 20 is arranged in a specific pattern, with predetermined spacing, so that when the tire rotates a whole image is displayed, as in FIG. 2.

Referring now to FIG. 2 the tire with rotational visual display 10 is illustrated when the tire is rotating. As the tire 10 rotates the first image becomes a second image 18. The rotation of the tire with rotational visual display 10 spins the outer face 12 so quickly that the first image 20 appears to look like a second image 18 or whole image thereby having the ability to display a word, phrase, picture, brand name, logo or the like. When the tire 10 rotation reaches a predetermined speed, specific to the spacing of the first image 20, the second image 18 is shown. The second image 18 may be a successful and fun marketing tool to allow businesses to promote their products by placing their company names, logos, or slogans on the tire with rotational visual display 10.

The predetermined speed may be determined based upon the type of driving performed within a specific vehicle or the demographic desired to be targeted by the marketing. For example, if the vehicle is ideally driven in residential or city streets, where the speeds are typically within the range of 25-45 miles per hour, the predetermined speed may be within that range and thus the first image is created accordingly. Alternatively, if the vehicle is typically driven on the highway, like a semi-truck or other transporting vehicle, where the typical speeds range from 45-100 miles per hour when the predetermined speed may be within that range and the first image is created accordingly. Finally, business may desire to market their goods on professional driving vehicles, like Nascar®, or Formula 1® vehicles, thus the predetermined speed ranges upwards of 100-200 miles per hour.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A tire with rotational visual display comprising:
a. a tire, where the tire includes an outer face, an inner edge and an outer edge;
b. a first fragmented image on the outer face, where the first image is visible when the tire is not rotating; and
c. a second image on the outer face, where the second image is visible when the tire rotates at a predetermined speed and the second image is formed from the first fragmented image.

2. The tire with rotational visual display according to claim 1, where the second image displays one of at least a word, phrase, picture, brand name, logo and slogan.

3. The tire with rotational visual display according to claim 1, where the first image is arranged with a specific spacing.

4. The tire with rotational visual display according to claim 1, where the first image is non-decipherable when the tire is not rotating.

5. The tire with rotational visual display according to claim 1, where the predetermined speed includes a range from about 25 mile per hour to about 200 miles per hour.
